(19) United States
(12) Patent Application Publication
(10) Pub. No.: US 2019/0166753 A1
(43) Pub. Date: Jun. 6, 2019

(54) RECONFIGURABLE TILLAGE SYSTEM

(71) Applicant: Tillage Management Incorporated, Tulare, CA (US)

(72) Inventors: Mark Hoffman, Tulare, CA (US); Kevin G. McDonald, Tulare, CA (US)

(21) Appl. No.: 16/270,859

(22) Filed: Feb. 8, 2019

Related U.S. Application Data
(63) Continuation-in-part of application No. 13/758,896, filed on Feb. 4, 2013.
(60) Provisional application No. 61/598,279, filed on Feb. 13, 2012.
(60) Provisional application No. 61/594,995, filed on Feb. 3, 2012.

(51) Int. Cl. A01B 79/00; A01B 63/24; A01B 49/02

(52) U.S. Cl. CPC A01B 79/005; A01B 49/027; A01B 63/24

(57) ABSTRACT

A reconfigurable tillage system that can perform multiple tillage functions in a single pass is provided. The reconfigurable tillage system of the present disclosure further manages the flow of soil passing through the system to ensure a uniform result without disturbing the surrounding land and without the distribution and/or build-up of soil outside the desired tillage pathway.

### CROSS REFERENCE TO RELATED APPLICATIONS

This application is a continuation-in-part of U.S. patent application Ser. No. 13/758,896, filed Feb. 4, 2013, which claims the benefit of U.S. Provisional Application Ser. No. 61/598,279, filed Feb. 13, 2012 and of U.S. Provisional Application Ser. No. 61/594,995, filed Feb. 3, 2012, the disclosures of which are incorporated herein by reference.

### TECHNICAL FIELD

The present disclosure relates generally to the field of soil management and farm implements. More particularly, the present disclosure relates to tillage systems. Specifically, the present disclosure relates to a one pass tillage system for use in narrow or confined areas, such as in orchard rows, that controls and directs soil flow through the system to prevent distribution of tilled soil into unwanted areas on either side of the tillage system.

### BACKGROUND

### Background Information

Tillage is the process of preparing soil for the raising of crops and, in its broadest sense, involves mechanical agitation of the soil. Primary tilling typically involves deeper penetration of the soil and may produce a rough, clumpy surface. Secondary tilling is generally shallower than primary tilling and produces a smoother surface. Depending on specific tillage requirements, soil that has undergone primary tilling may subsequently be subject to secondary tilling to produce a desired surface texture that is conducive to the crop to be planted or to the machinery used to plant the crop.

Accordingly, a wide variety of implements have been developed for various stages of tilling. Typically, these implements are deployed in multiple passes of the equipment through an area to be tilled. For example, the soil may first be worked with a disc implement to penetrate deeply into the soil and turn the disturbed soil over. This operation may produce large clods of soil, so equipment may make a second pass over the soil using tines or shanks to further break up and mix the soil. Equipment that includes a reel implement with rotating blades may make a third pass over the soil to further reduce the size of the soil clods. Finally, one or more rollers may be moved over the soil to impart a desired surface texture to the soil.

During the growing season, previously tilled soil tends to compact. This compaction may be further aggravated during harvesting when heavy machinery passes through the field. In addition, the harvesting process tends to leave behind a residue of plant matter in the field. Tilling the soil helps to reduce compaction and aerate the soil, which is necessary to promote crop growth. Tilling may also serve to mix the residual plant matter into the soil where it can decompose, providing nutrients for the next crop. Further, tilling can mechanically destroy weeds and other undesirable undergrowth plants by tearing them out by the roots and mixing them into the soil where they also decompose and provide nutrients.

For general applications, tilling the soil is typically done using a tractor and one or more tilling implements that are pulled behind the tractor. These implements are steered through the area being tilled in a series of passes, thus any soil that is disturbed but not fully tilled is typically gathered in the next pass. The exception to this is the edges of the area being tilled where soil may accumulate and may disturb the boundaries of the field. If these areas are managed, the disturbed but untilled soil may contaminate these boundaries.

Additionally, in areas with limited space, such as in orchards and/or vineyards, the ground between the rows of trees or vines may benefit from soil management. Tilling the areas between the rows of an orchard or vineyard may serve to aerate the soil and allow water and nutrients to better reach the roots of the plants in neighboring rows. Further, any vegetation that has grown between the rows, including seedlings of new orchard plants, weeds, and undergrowth, may be mixed back into the soil, providing additional nutrients to the neighboring rows of plants. Finally, mummy fruits and nuts, i.e. the fruits and nuts that are left behind after harvesting that tend to populate the orchard floors, may be mechanically broken down and put under the soil. This may provide further nutrients as well as help to prevent unwanted pests, weeds, and/or diseases from affecting the orchard or vineyard.

Tilling in these applications, however, is difficult as there is limited space between rows. Additionally, it is undesirable to have soil accumulate under the plants in the rows adjacent the area being tilled. Over time, the build-up of soil on the berms adjacent the area being tilled can have negative effects on the orchard/vineyard plants. The build-up of soil may also affect ground that has been previously leveled for harvest preparation. In either instance, the excess soil may have to be removed. Soil removal can increase both the time and cost associated with tilling between the rows, thus reducing the benefits realized by the act of tilling. The soil being tilled may include seeds and cuttings from unwanted vegetation, such as weeds, and consequently soil moved outwardly from the tilling equipment and onto the berms of the area being tilled may contaminate areas that have been previously treated with herbicide, thus rendering those treatments less effective.

### SUMMARY

The present application addresses these and other issues by providing a reconfigurable tillage system that is able to perform multiple tillage functions in a single pass. The reconfigurable tillage system of the present disclosure further manages the flow of soil passing through the system to ensure a uniform result without disturbing the surrounding land and without the distribution and/or build-up of soil outside the desired tillage pathway.

In one aspect, the present disclosure may provide a method of soil flow management comprising traversing an area of land to be tilled with a tillage system having a frame carrying a first tillage assembly and a second tillage assembly thereon; processing the soil underneath the tillage system with the first tillage assembly and the second tillage assembly as the tillage system travels forwardly across the area of land; directing a first part of the processed soil as a first soil flow toward a first side of the tillage system with one of the first tillage assembly and the second tillage assembly; and containing at least a part of the first soil flow within a first side boundary and within an operational width of the tillage system utilizing a first deflector.

This exemplary embodiment or another exemplary embodiment may further provide directing a second part of the processed soil as a second soil flow toward a second side of the tillage system with the other of the first tillage assembly and the second tillage assembly; and containing the second soil flow within a second side boundary and within the operational width of the tillage system utilizing a second deflector. This exemplary embodiment or another exemplary embodiment may further provide capturing a part of the first soil flow that bypasses the second tillage assembly with a soil deflection plate and redirecting the part of the first soil flow back into the operational width of the tillage system.

This exemplary embodiment or another exemplary embodiment may further provide leaving a ground surface outside of the first side boundary and the second side boundary of the tillage system substantially undisturbed. This exemplary embodiment or another exemplary embodiment may further provide that the first tillage assembly comprises a first tillage implement and a second tillage implement and the method further comprises positioning the second tillage between 3 inches and 6 inches rearwardly from the first tillage implement. This exemplary embodiment or another exemplary embodiment may further provide positioning the second tillage between 3.4 inches and 5.7 inches rearwardly from the first tillage implement.

This exemplary embodiment or another exemplary embodiment may further provide wherein the first tillage assembly includes a first tillage implement and the method further comprises locating the first deflector at least partially rearwardly from the first tillage implement. This exemplary embodiment or another exemplary embodiment may further provide wherein the second tillage assembly includes a second tillage implement and the method further comprises: locating the second deflector at least partially rearwardly from the second tillage implement. This exemplary embodiment or another exemplary embodiment may further provide wherein the second tillage assembly further comprises an additional tillage implement and the method further comprises locating a soil deflection plate at least partially forwardly from the additional tillage implement and opposite the second deflector. This exemplary embodiment or another exemplary embodiment may further provide processing substantially all of the soil through the additional tillage implement carried by the second tillage assembly. This exemplary embodiment or another exemplary embodiment may further provide locating a finishing implement rearwardly of the additional tillage implement and applying the finishing implement to the substantially all of the soil processed by the tillage system.

In another aspect, the present disclosure may provide a method of tilling comprising analyzing a first area of land to be tilled; determining tillage requirements of the first area of land; selecting a first plurality of tillage implements suitable to perform the tillage requirements of the first area of land; configuring a tillage system with a frame to the tillage requirements of the first area of land; installing the first plurality of tillage implements onto the frame; traversing the first area of land with the tillage system; tilling the first area of land with the plurality of first tillage implements; analyzing a second area of land to be tilled; determining the tillage requirements of the second area of land; selecting a second plurality of tillage implements suitable to perform the tillage requirements of the second area of land; removing the first plurality of tillage implements from the frame; reconfiguring the tillage system to carry the second plurality of tillage implements; installing the second plurality of tillage implements onto the frame; and tilling the second area of land with the second plurality of tillage implements.

This exemplary embodiment or another exemplary embodiment may further provide that the installation and removal of the first plurality of tillage implements and the second plurality of tillage implements are performed without using tools. This exemplary embodiment or another exemplary embodiment may further provide that the analyzing of the first area of land and the analyzing of the second area of land are performed prior to installing the first plurality of tillage implements onto the frame. This exemplary embodiment or another exemplary embodiment may further provide installing a first deflector proximate a first side of the tillage system; installing a second deflector proximate a second side of the tillage system; and defining an operational width of the tillage system between the first deflector and the second deflector. This exemplary embodiment or another exemplary embodiment may further provide containing substantially all of the soil processed by the tillage system within the operational width.

In another aspect, the present disclosure may provide a tillage system comprising a frame having a first side and a second side; a front tillage assembly engaged with the frame and carrying at least one tillage implement thereon; a first deflector provided on the front tillage assembly and defining an operational first side boundary of the tillage system; a rear tillage assembly engaged with frame and carrying at least one tillage implement thereon; a second deflector provided on the rear tillage assembly and defining an operational second side boundary of the tillage system; wherein the first deflector and the second deflector are adapted to contain processed soil between the first side boundary and the second side boundary.

This exemplary embodiment or another exemplary embodiment may further provide a soil deflection plate in operational communication with the rear tillage assembly, said soil deflection plate being located laterally spaced apart from and opposite the second deflector. This exemplary embodiment or another exemplary embodiment may further provide that the frame includes an arched section which is located between the front tillage assembly and the rear tillage assembly. This exemplary embodiment or another exemplary embodiment may further provide wherein the front tillage assembly comprises a first tillage implement and a second tillage implement located in close proximity to each other; and wherein the rear tillage assembly comprises a third tillage implement and a fourth tillage implement, and the third tillage implement and fourth tillage implement are located in close proximity to each other.

In another aspect, the present disclosure may provide a reconfigurable tillage system comprising, in combination, a frame and a plurality of tillage implements that are detachably engageable with the frame in a variety of positions; wherein the frame comprises a first longitudinal frame member extending longitudinally between a first end and a second end of a tillage system; a first lateral frame member and a second lateral frame member that are engaged with the first longitudinal frame member and extend from a first side to a second side of the tillage system; a plurality of mounting members engaged with one or more of the first longitudinal frame member, the first lateral frame member, and the second lateral frame member; and a plurality of connectors configured to detachably engage with the plurality of mounting members without the use of tools; and wherein the plurality of tillage implements includes a first tillage implement to perform a first task and a second tillage implement to perform a second task; and wherein the first tillage implement and the second tillage implement are selectively detachably engaged with the plurality of mounting members using the plurality of connectors and without using tools, and the first tillage implement may be located on the frame one of in front of the second tillage implement and behind the second tillage implement. The plurality of tillage implements may comprise multiple additional tillage implements such that all of the plurality of tillage implements are not engageable with the frame at a same time; and wherein a first combination of the plurality of tillage implements is engaged with the frame to till a first area of land and a second combination of the plurality of tillage implements is engaged with the frame to till a second area of land. The first longitudinal frame member has an inverted V-shape and the plurality of tillage implements are suspended from the frame.

### BRIEF DESCRIPTION OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a right side elevation view of a tillage system according to an aspect of the present disclosure.

FIG. 1A is an enlarged right side elevation view of the highlighted area identified in FIG. 1.

FIG. 1B is a right side elevation view of the tillage system showing optional equipment installed thereon according to an aspect of the present disclosure.

FIG. 2 is a left side elevation view of the tillage system shown in FIG. 1.

FIG. 2A is an enlarged left side elevation view of the highlighted area of FIG. 2.

FIG. 3 is a top plan view of the tillage system of FIG. 2.

FIG. 4 is a rear, top perspective view of the frame of the tillage system.

FIG. 5 is a right side elevation view of the tillage system showing the tillage system in operation.

FIG. 6 is a partial top plan view of the tillage system shown in FIG. 5.

Similar numbers refer to similar parts throughout the drawings.

### DETAILED DESCRIPTION

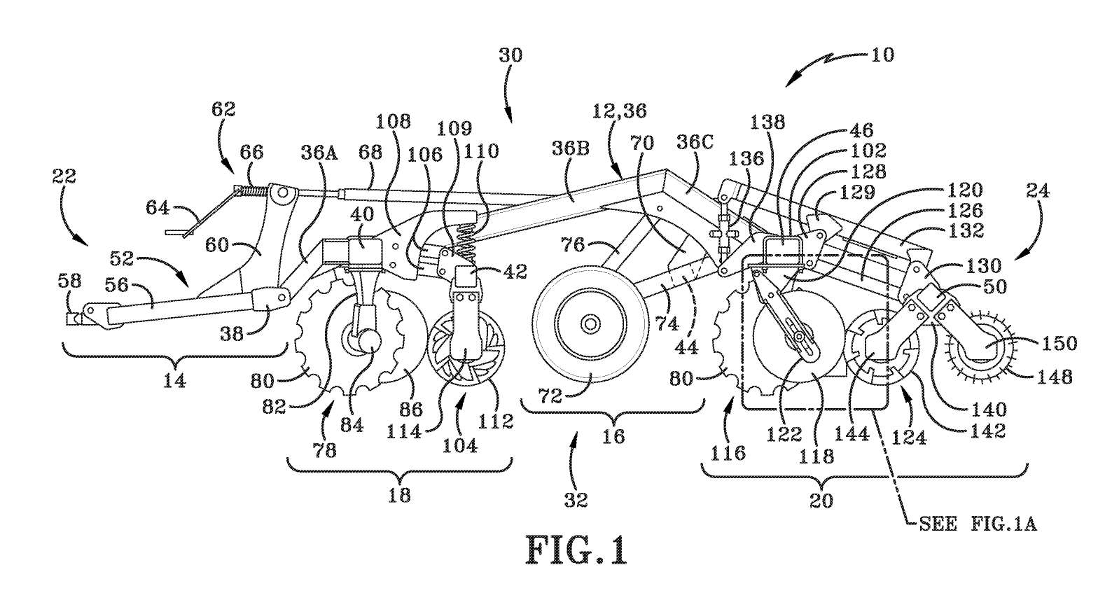

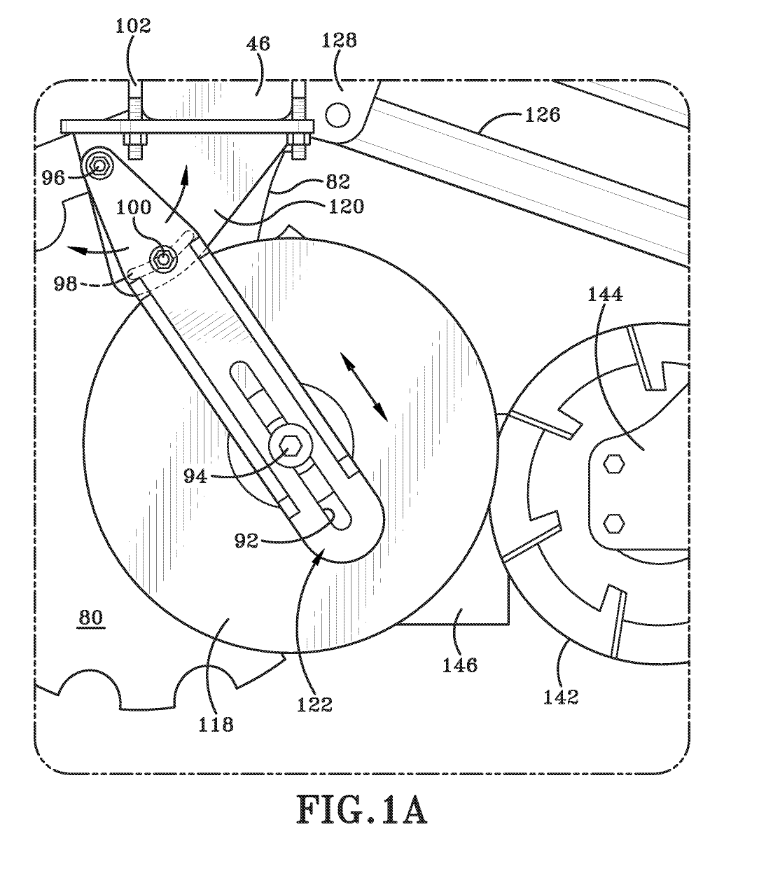

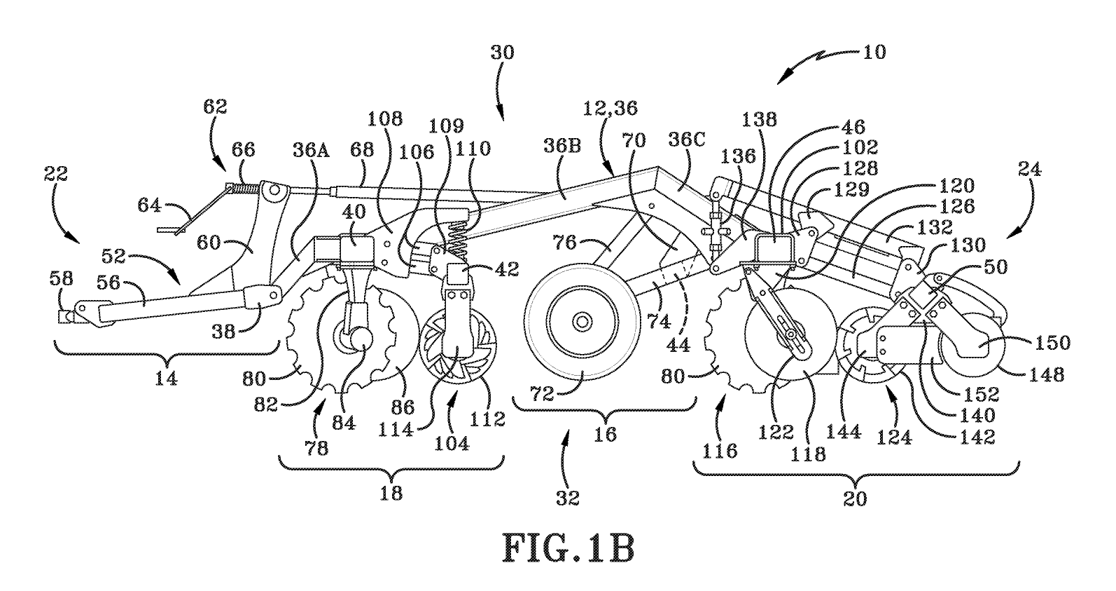

With reference to FIGS. 1-4, a tillage system is shown and generally indicated at reference 10. Tillage system 10, in its most general sense, may be a trailer or similar device to be towed behind a vehicle, such as a tractor, across an area of land to be tilled as discussed further herein. Tillage system 10 includes a frame 12, a hitch assembly 14, a wheel assembly 16, a first, or front tillage assembly 18, and a second, or rear tillage assembly 20.

According to one aspect, tillage system 10 may include a control linkage, control panel, electric, and/or hydraulic lines operationally attached thereto as necessary to operate pneumatic, hydraulic, or electrical devices that may be incorporated into tillage system 10 and/or carried by frame 12. These various components have been omitted from the figures for purposes of clarity and will not be discussed in any detail herein.

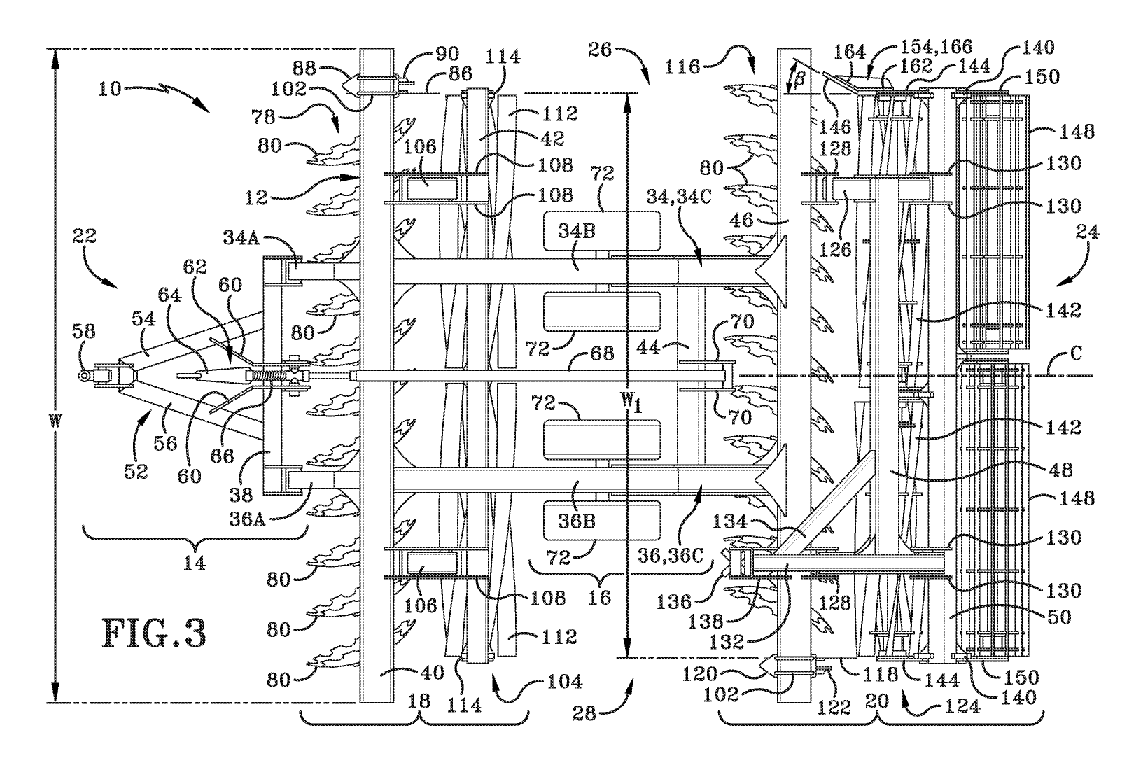

Tillage system 10 has a front end 22 defined as the end which connects to the vehicle for towing. Tillage system 10 includes a rear end 24 that is spaced apart from front end 22 defining a longitudinal direction therebetween and further defining the general direction of travel of tillage system 10. Tillage system 10 may also have a first side 26 spaced apart from a second side 28 (best seen in FIG. 3) defining therebetween a lateral direction that is generally perpendicular to the direction of travel for tillage system 10. Centerline “C”, as best seen in FIG. 3, may be an imaginary line drawn down center of tillage system 10 and between front end 22 and rear end 24 and along the longitudinal length thereof. Centerline “C” may bisect tillage system 10 into a left side and a right side. When viewing system 10 from front end 22 (i.e., looking rearwardly toward the front end 22 from the perspective of a person who is driving the vehicle towing tillage system 10), the first side 26 of tillage system 10 is left of centerline “C” and therefore comprises a left side of system 10. The second side 28 of tillage system is to the right of centerline “C” and therefore comprises a right side of tillage system 10.

Tillage system 10 may further have a top side 30 spaced apart from a bottom side 32 and defining a vertical direction therebetween. Top side 30 may be defined as the portion of tillage system 10 facing upwards towards the sky while bottom side 32 may be defined as the portion of tillage system 10 facing downwards towards and/or further engaging the ground as discussed further herein.

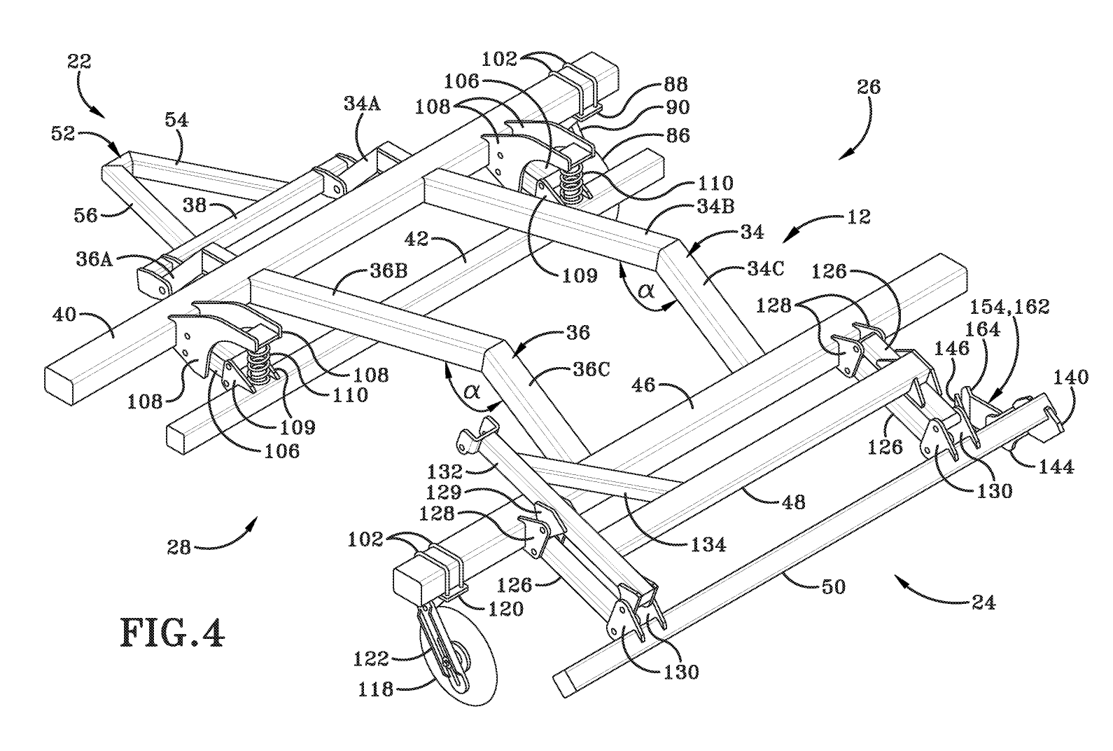

With continued reference to FIGS. 1-4, but as best shown in FIGS. 3 and 4, frame 12 may have a first longitudinal frame member 34 which may be positioned to the left of centerline “C” and a second longitudinal frame member 36 which may be positioned to the right of centerline “C”. These first and second longitudinal frame members 34, 36 may also be referred to herein as left and right longitudinal frame members, respectively. First and second longitudinal frame members 34, 36, may be laterally spaced apart from each other and may be oriented substantially parallel to one another. First and second longitudinal frame members 34, 36 are configured to provide frame 12 with an arched shape (when tillage system 10 is viewed from the side). The arched shape may allow for easier servicing of tillage system 10 as well as enabling easier tool-free implement installation and removal, as will be discussed later herein. First and second longitudinal frame members 34, 36 may each include three sections, namely, a front section 34A, 36A, a middle section 34B, 36B, and a rear section 34C, 36C. According to one aspect, each of the first and second longitudinal frame members 34, 36 may have an inverted ‘V’ shape when viewed from the side. The inverted “V” shape may be provided by middle sections 34B and 36B of first and second longitudinal frame members 34 and 36 being oriented at an angle α (FIG. 4) relative to the associated rear section 34C and 36C, respectively. According to one aspect, the angle a may be in a range from about 110 degrees up to about 150 degrees. According to another aspect, the angle α may be approximately 133 degrees.

Frame 12 may also include a plurality of lateral frame members that may extend substantially perpendicular to first and second longitudinal frame members 34, 36. These lateral frame members may be numbered from the front end 22 of tillage system 10 to the rear end 24 of tillage system 10, beginning with first lateral frame number 38 as the forwardmost lateral frame member and ending with seventh lateral frame member 50 as the rearward most lateral frame member. Accordingly, behind first lateral frame member 38 is second lateral frame member 40. Third lateral frame member 42 is behind second lateral frame member 40. Fourth lateral frame member 44 is behind third lateral frame member 42. Fifth lateral frame member 46 is behind fourth lateral frame member 44 with sixth lateral frame member 48 and seventh lateral frame member 50 following in order behind fifth lateral frame member 46. The first through seventh lateral frame members 38-50 are spaced apart longitudinally from each other and all lateral frame members 38-50 may be substantially parallel to each other.

One or both of second lateral frame member 40 and fifth lateral frame member 46 has a lateral width that defines the overall operating width “W” (FIG. 3) of tillage system 10. Width “W” of tillage system 10 may vary according to the desired implementation and use of tillage system 10. According to one aspect, width “W” may be approximately 11 feet. According to another aspect, width “W” may be any one of approximately 6 feet, 7 feet, 8 feet, 9 feet, or 10 feet. It will be understood that any desired width of second lateral frame member 40 and fifth lateral frame member 46 may be utilized. According to another aspect, width “W” may be greater than 11 feet.

According to one embodiment, frame 12 may comprise a central support frame that may further support one or more wings (not shown) which are pivotally connected to frame 12. These wings may support additional tillage implements. Further according to this embodiment, the wings may increase the overall width “W” of tillage system 10 and may allow tillage system 10 to be adapted for multiple uses, including tilling in narrow areas or space restricted areas, as well as for tilling in larger, open areas. In various embodiments, the overall width in the storage position may not exceed twelve feet so that the tillage system 10 may be transported on public roads, if desired.

According to one aspect, first through seventh lateral frame members 38-50 form supports and/or mounting points for individual tillage implements as discussed further herein. According to another aspect, first lateral frame member through to seventh lateral frame member 38-50 form mounting points for secondary frame members carrying one or more tillage implements thereon, as discussed further herein.

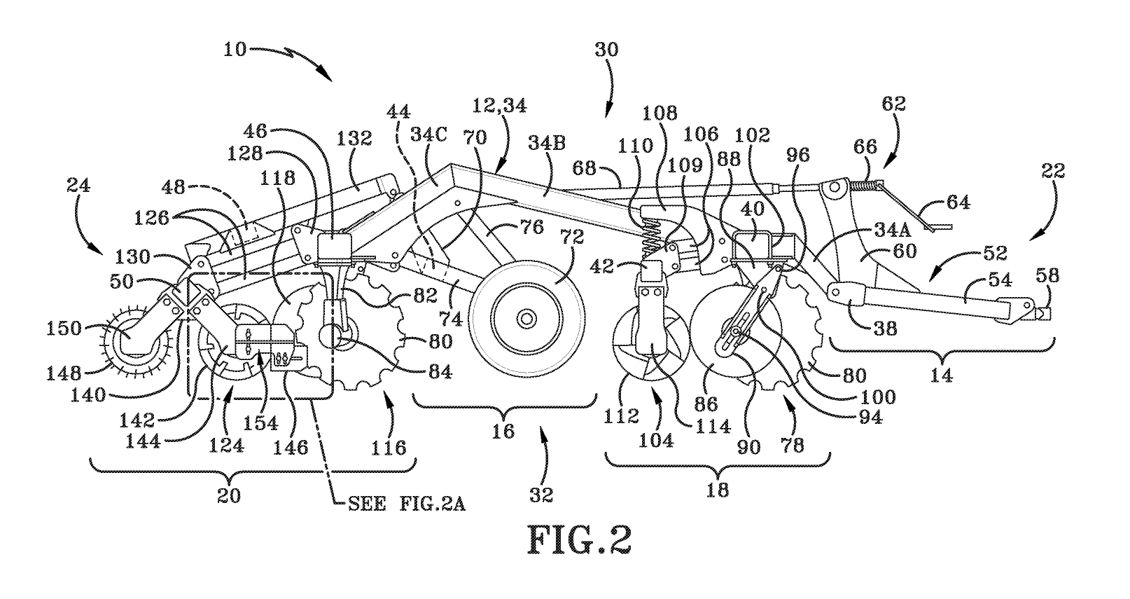

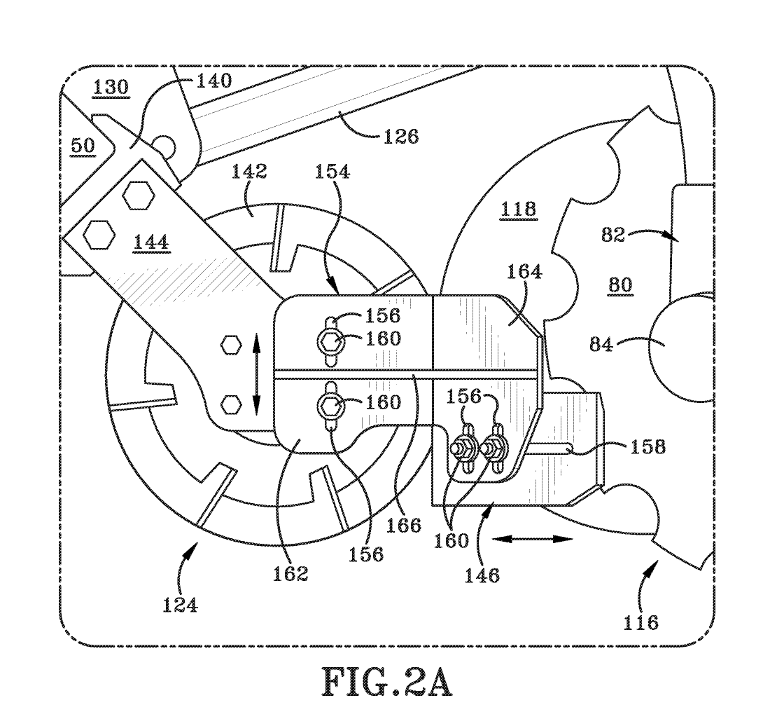

Lateral frame members 38-50 may be operationally connected or secured to first and second longitudinal frame members 34, 36 in any suitable way, including but not limited to pins, locking pins, bolts, clamps, rivets, straps, welding, adhesive bonding, and the like. According to one aspect, these connections may be reinforced with additional flanges and/or plates that may further strengthen and support the connections between lateral frame members 38-50 and first and second longitudinal frame members 34, 36. According to another aspect, some connections may be fixed, such as by welding and/or rivets, while other connections may be removable, such as through the use of pins or bolts. First and second longitudinal frame members 34, 36, as illustrated, are divided into multiple sections. Specifically, as discussed above, first and second longitudinal frame members 34, 36 may have a forward section 34A and 36A, respectively, which may extend between first and second lateral frame members 38 and 40. Middle sections 34B and 36B of first and second longitudinal frame members 34, 36 may extend rearward from second longitudinal frame member 40, passing over third lateral frame member 42, as seen in FIGS. 1 and 2. Middle sections 34B and 36B of first and second longitudinal frame members 34, 36 angle upwards and thereby create a forward portion of the arch of frame 12, as discussed above. The rearward end of middle sections 34B and 36B connect to rear sections 34C and 36C of first and second longitudinal frame members 34, 36. Rear sections 34C, 36C angle downwards and connect to fifth lateral frame member 46 towards the rearmost end of first and second longitudinal frame members 34, 36.

Referring still to FIGS. 1-4, hitch assembly 14 includes a hitch frame 52 that had a first frame arm 54 and a second frame arm 56 extending forward from first lateral frame member 38 of frame 12 to form the hitch frame 52. According to one aspect, hitch frame 52 may be generally A-shaped and have the general form of an A-frame. According to another aspect, hitch frame 52 may be any other suitable frame operable to connect tillage system 10 to a vehicle. Hitch frame 52 may have a hitch 58 positioned at its foremost end for operable connection to the vehicle. Hitch 58 may be any hitch assembly suitable to couple tillage system 10 to a vehicle to pull tillage system 10 across an area to be tilled. Hitch assembly 14 may further carry pneumatic or hydraulic connectors and tubing, or electrical connectors and wiring, as necessary to operate pneumatic, hydraulic, or electrical devices that may be incorporated into tillage system 10 and may be operatively engaged with compatible systems on the towing vehicle if needed. These various components have been omitted from the figures for purposes of clarity.

Hitch assembly 14 may further include a support arm 60 extending vertically from proximate the rearwardmost portion of hitch frame 52. Support arm 60 may connect to one or more of first frame arm 54, second frame arm 56, and/or first lateral frame member 38 and extend generally vertically therefrom and supports a wheel assembly adjustment mechanism 62 above the hitch frame 52. Wheel assembly adjustment mechanism 62 may be a manual or power-operated adjustment mechanism for raising and lowering the wheel assembly 16, as discussed further herein. As illustrated, wheel assembly adjustment mechanism 62 may include an adjustment handle 64, a tension spring 66, and an adjustment linkage 68 which may connect to adjustment handle 64 on a forward end to an adjustment arm 70 carried by the wheel assembly 16. It will be understood that other types of wheel assembly adjustment mechanisms may be utilized with tillage system 10.

Wheel assembly 16 has at least one ground engaging wheel 72 to support tillage system 10 as it is towed across a ground surface by a vehicle. Wheel assembly 16 may be height adjustable such that wheels 72 may be lowered to engage or raised to disengage from the ground as desired. As discussed further herein, wheel assembly 16 may be engaged with frame 12 by fourth lateral frame member 44 which may be rotatably connected to each of first and second longitudinal frame members 34, 36. The rotatable connection therebetween may allow the rotation of wheel assembly 16 between a stowed condition wherein wheels 72 do not engage the ground and an operational condition wherein wheels 72 are engaged with the ground. Wheels 72 may be engaged with fourth lateral frame member 44 by one or more wheel support members 74 and/or one or more pistons 76. Pistons 76 may be hydraulic, or may be any other suitable type of piston. Pistons 76 may extend between fourth lateral frame member 44 and wheel assembly 16 to further assist or otherwise allow adjustment of wheels 72 between the stowed and operational conditions.

Front tillage assembly 18 includes second lateral frame member 40 and third lateral frame member 42. One or more tillage implements may be supported on second lateral frame member 40 and/or third lateral frame member 42. The one or more tillage implements form part of the front tillage assembly 18. Each tillage implement may be selectively operational to perform a tillage function to the soil such as cutting, turning, breaking, loosening, moving, contouring, terracing, smoothing, leveling, shattering, bulldozing, pulverizing, mixing, injecting, compacting, and the like, as discussed further herein. Further tillage functions may involve vegetation growing in the soil that is to be tilled. For example, some of the tillage implements may cut vegetation and/or may pull vegetation out of the soil, and/or may turn vegetation under and into the soil, as discussed further herein.

According to one aspect, second lateral frame member 40 may be fixedly connected to first and second longitudinal frame members 34, 36 or alternatively may be pivotably connected thereto. Second lateral frame member 40 may support a first tillage implement 78. According to another aspect, first tillage implement 78 may be alternatively supported by a secondary frame member (not shown) that may be coupled to frame 12 to allow for modular replacement thereof. Further, first tillage implement 78 may be configured for removable connection to frame 12 such that the entirety of first tillage implement 78 may be installed or removed from frame 12 without the need for tools or other equipment, such as a lift or trailer jack.

As illustrated, first tillage implement 78 comprises a plurality of tilling discs 80 that are spaced laterally apart from each other at intervals across at least a portion of the lateral width of second lateral frame member 40. Each disc 80 of the plurality of discs 80 may be suspended downwardly from second lateral frame member 40 and be individually coupled to a rotating disc mount 82. Disc mount 82 may include a disc axle 84 that allows the associated disc to rotate about the axle 84 as tillage system 10 is employed in an area of land to be tilled. Discs 80 may be any type of tillage disc 80 suitable for the desired implementation. For example, discs 80 may be plain, notched, flat, concave, or any other disc profile, size, and/or shape as dictated by the tillage requirements of the area to be tilled. According to another aspect, first tillage implement 78 may include more than one type of disc 80 therein. The discs 80 may serve to break up the soil to a certain depth and turn the disturbed soil over.

Each individual disc 80 may be slightly angled slightly relative to the direction of travel of tillage system 10 as best seen in FIG. 3. The angling of discs 80 may cause some soil to be displaced to one side of tillage system 10 as discs 80 engage the soil in the area being tilled. When viewed from the towing vehicle, the angling of discs 80 in first tillage implement 78 may tend to throw at least some of the tilled soil laterally to the left side of tillage system 10 with respect to the direction of travel. If the discs are angled differently, they might displace some of the tilled soil laterally to the right side of tillage system 10. This lateral movement of the soil (whether to the left or right of the direction of travel) from first tillage implement 78 is referred to herein as a first soil flow through front tillage assembly 18. In accordance with an aspect of the present disclosure, a first deflector 86 is operably engaged with second lateral frame member 40 toward an outermost end of the first tillage implement 78. First deflector 86 is provided to contain at least some and preferably most or all of the first soil flow within the operational width “W1” of tillage system 10. In other words, first deflector 86 is positioned so as to try and prevent tilled soil from moving outwardly beyond an outermost end of second lateral frame member 40.

First deflector 86 may be detachably mounted to second lateral frame member 40 via a first deflector mount 88. A first deflector arm 90 may be pivotably attached to first deflector mount 88 and angled downward therefrom. First deflector arm 90 may have a first adjustment slot 92 defined therein which may accept a first adjustment screw 94 to allow adjustment of first deflector 86 up and down along the length of first deflector arm 90. First deflector arm 90 may be pivotably mounted to first deflector mount 88 by a pivot bolt 96. According to one aspect, pivot bolt 96 may be a pin, screw, or any other type of fastener that may allow first deflector arm 90 to pivot relative to first deflector mount 88. Additionally, first deflector mount 88 may include second adjustment slot 98 through which a second adjustment screw 100 may be inserted allowing pivotable motion of first deflector 90 relative to first deflector mount 88. First deflector mount 88 may be connected to second lateral frame member 40 via U-bolts 102 as depicted in the figures or by any other fastening means as dictated by the desired implementation.

It will be understood that first deflector mount 88 may be positioned anywhere along the lateral length of second lateral frame member 40. In particular, first deflector mount 88 may be engaged with second lateral frame member 40 proximate the outermost end toward which soil will be moved by the angled discs 80. First deflector mount 88 may be engaged with second lateral frame member 40 so that the first deflector 86 extends at least partially rearwardly beyond a rearmost region of first tillage implement 78. First deflector 86 may therefore occupy or otherwise enclose at least a portion of a space defined between first tillage implement 78 and second tillage implement 104 located rearwardly of first tillage implement 78. The operational position of first deflector 86 may help to define a first side boundary of tillage system 10, as discussed further below. First deflector 86 may be positioned flush with or just slightly laterally outside of an outermost side of second tillage implement 104 78. This arrangement helps to ensure rearward soil flow rearwardly through tillage system 10 instead of sideways out of tillage system 10. Soil flow will be discussed further herein.

According to one aspect, first deflector 86 may be a flat coulter blade or the like. According to another aspect, first deflector 86 may be any disc or other deflection device suitable for the desired application, as discussed further herein.

Although first tillage implement 78 is discussed and shown herein as including a row of discs 80, it will be understood that this particularly illustrated first tillage implement 78 is by way of example only. Any other type of tillage implement may be engaged with frame 12 in the location occupied by first tillage implement 78. As will be discussed hereafter, a second tillage implement, third tillage implement etc. are engaged with frame 12. It should be understood that the particular types of tillage implement is exemplary and should not be construed to limit tillage system 10 only to the illustrated configuration. Any other type of tillage implement may be selected and engaged with frame 12 in any of the disclosed engagement locations. The user, as indicated later herein, will analyze the tilling requirements for a particular area of land and will then engage tillage implements with the frame 12 so that they will perform different and various tilling functions in the desired order so that the soil is tilled as desired. The type of tillage equipment engaged with frame 12 at any particular location is therefore to be understood as being generally dictated by the specific tillage requirements of the area of land to be tilled and the choice of the user.

Front tillage assembly 18 further includes second tillage implement 104 which is supported by third lateral frame member 42 and is positioned to engage the soil to be tilled as discussed further herein. As depicted in FIGS. 1-4, third lateral frame member 42 may be operationally engaged with second lateral frame member 40 by front coupling arms 106. Front coupling arms 106 may be pivotably attached on a forward side to one or more suspension flanges 108 that may be fixedly attached to the rear side of second lateral frame member 40 and may extend rearwards and vertically therefrom. Front coupling arms 106 may also be pivotably attached to one or more forward mounting flanges 109 that may be fixedly attached to the front side of third lateral frame member 42 and may extend forwardly therefrom. Front coupling arms 106 may be adapted to releasably couple third lateral frame member 42 and/or second tillage implement 104 to frame 12 via one or more pins, bolts, or the like which may be placed through holes defined in the suspension flanges 108, forward mounting flanges 109, and/or lateral frame members 40 and/or 42.

It will be understood that flanges, such as suspension flanges 108, forward mounting flanges 109, and other mounting flanges (discussed below), may include matching flanges on either side of tillage system 10. For example, suspension flanges 108 are best seen in FIG. 3 as being present on both the left and right sides of centerline “C”, and references thereto are understood to apply equally to both suspension flanges 108, unless specifically stated otherwise. Similarly, references to other flanges, such as forward mounting flanges 109 and other mounting flanges discussed below, are understood to include all similarly situated and depicted flanges, unless specifically stated otherwise.

Front coupling arms 106 may allow second tillage implement 104 to move up and down over rough terrain as dictated by the tillage requirements of the area to be tilled. Suspension flanges 108 may further include suspension springs 110 to further support the weight of second tillage implement 104 as well as to bias the second tillage implement 104 into a downward ground-engaging position. According to one aspect, the suspension springs 110 may serve as shock absorbers to allow second tillage implement 104 to move up and over obstacles encountered as the area of land is being tilled.

Second tillage implement 104 may be any desired tillage implement as determined according to the specific tillage requirements of the area to be tilled. According to one aspect, and as shown in the figures, second tillage implement 104 may be a first reel 112. The first reel 112 incudes a first reel mount 114 that permits rotational movement of first reel 112 about an axis oriented perpendicular to in the direction of travel of tillage system 10. First reel 112 may include a plurality of blades arranged in a generally helical pattern about first reel mount 114. The blades may cut or pull vegetation growing in the soil being tilled or may cut into and break up the soil itself. Suspension springs 110 may further provide a continuous downward force on first reel 112.

As with first tillage implement 78, second tillage implement may be alternatively supported by a secondary frame member that may be coupled to frame 12 to allow modular replacement thereof. Further, second tillage implement 104 may be configured for removable connection to frame 12 such that the entirety of second tillage implement 104 may be installed or removed from frame 12 without the need for tools or other equipment, such as a lift or trailer jack.

Front coupling arms 106 and suspension flanges 108 may be sized and arranged so as to position second tillage implement 104 closely behind first tillage implement 78. In other words, second tillage implement 104 may be located in close proximity to first tillage implement 78. According to one aspect, where first tillage implement 104 includes a plurality of discs 80 and second tillage implement 104 is a first reel 112, the distance between the rearmost edge of any one of the plurality of discs 80 and the forwardmost edge of the first reel 112 may be in a range from about 3 inches up to about 6 inches. According to another aspect, this distance may be within a range of from approximately 3.4 inches up to approximately 5.7 inches. According to another aspect, this distance may be approximately 5.5 inches. The close proximity between the first tillage implement 78 and the second tillage implement 104 may provide additional benefits in tillage operations in that it provides tillage system 10 the ability to maximize the work performed on the soil being tilled. The flow of soil through tillage system 10 is discussed further below.

Tillage system 10 may further include a rear tillage assembly 20 situated rearwardly behind wheel assembly 16 and spaced a distance longitudinally apart from front tillage assembly 18. Wheel assembly 16 may be raised or lowered through the space between front tillage assembly 18 and rear tillage assembly 20. Rear tillage assembly 20 may include a third tillage implement 116 and a fourth tillage implement 142. Third tillage implement 116 may be substantially similar to first tillage implement 78 and include a plurality of discs 80 spaced apart at intervals across the lateral width of fifth lateral frame member 46. The discs 80 may be suspended downwardly from fifth lateral frame member 46 by a plurality of rotating disc mounts 82. Each disc mount 82 may include a disc axle 84 which allows rotational movement of discs 80 thereabout. It will be understood that similar to first tillage implement 78, the discs 80 of third tillage implement 116 may be discs of any type, profile, size, and/or shape, and third tillage implement 116 may include discs 80 of more than one type profile, size, and/or shape.

As with first tillage implement 78, discs 80 of third tillage implement 116 may be angled slightly relative to the direction of travel. As best seen in FIG. 3, the angling of discs 80 in third tillage implement 116 may be opposite in orientation to the angling of discs 80 in first tillage implement 78. Specifically, the discs 80 of first tillage implement 78 may be angled to a first side, such as towards the left side 28 of tillage system 10. The discs 80 of third tillage implement 116 may be angled to a second side, such as towards the right side of tillage system 10. Consequently, during a tilling operation the discs 80 of first tillage implement 78 may move some soil laterally to the first side of tillage system 10 (i.e., towards a first boundary side) and the discs 80 of second tillage implement 116 may move some soil laterally toward the second side of tillage system 10 (i.e., towards a second boundary side) with respect to the direction of travel of tillage system. The discs 80 of third tillage implement 116 may therefore move soil laterally, i.e., establish a second soil flow, toward the right.

As with prior tillage implements 78 and 104, third tillage implement 116 may be any other type of tillage implement as dictated by the specific tillage requirements of the area to be tilled. According to another aspect, third tillage implement 116 may be alternatively supported by a secondary frame member that may be coupled to frame 12 to allow modular replacement thereof. Further, third tillage implement 116 may be configured for removable connection to frame 12 such that the entirety of third tillage implement 116 may be installed or removed from frame 12 without the need for tools or other equipment, such as a lift or trailer jack.

In accordance with an aspect of the present disclosure, a second deflector 118 may be operably engaged with fifth lateral frame member 46 at an outermost right end of the third tillage implement 116. Second deflector 118 is provided to contain the second soil flow within the operational width “W1” of tillage system 10 and is preferably located on an opposite side of tillage system 10 from first deflector 86 if discs 80 on the first and third tillage implements are angled differently. If the discs 80 on the first and third tillage implements are angled substantially identically, then the second deflector 118 will be located on the same side of tillage system 10 as first deflector 86.

As illustrated in the attached figures, second deflector 118 is substantially identical to first deflector 86 except that second deflector 118 is provided on an opposite side of tillage system 10 from first deflector 86. According to one aspect, second deflector 118 may be a flat coulter blade or the like. According to another aspect, second deflector 118 may be any disc or other deflection device suitable for the desired application, as discussed further herein.

Second deflector 118 and the manner in which it is mounted and operates is discussed hereafter with reference to FIG. 1A. It should be understood that this description applies equally to first deflector 86 since the first and second deflectors may be mounted and function in substantially the same way. The same reference numbers for various components shown and discussed with respect to first deflector 86 may apply equally to second deflector 118. Referring to FIG. 1A, second deflector 118 may be operationally connected to fifth lateral frame member 46 via second deflector mount 120 and second deflector arm 122. Second deflector mount 120 may be operationally connected to fifth lateral frame member 46 by U-bolts 102 as depicted in the figures or by any other fastening means as dictated by the desired implementation. It will be understood that second deflector mount 120 may be positioned anywhere along the lateral length of fifth lateral frame member 46. However, as depicted and discussed herein, second deflector 118 may be positioned substantially flush with or just slightly outside of a lateral end of a fourth tillage implement 124 (discussed hereafter) for proper soil flow through tillage system 10, as discussed further herein. Second deflector 118 also extends slightly rearwardly from the third tillage implement 116 such that second deflector 118 may occupy or otherwise enclose at least a portion of the space between third tillage implement 114 and fourth tillage implement 124. Second deflector 118 may be positioned at the right side of third tillage implement 116 and may define a second side boundary of tillage system 10. Second deflector 118 helps to contain soil within the second side boundary of tillage system 10. The lateral distance between first deflector 86 and second deflector 118 may further define an operational width “W1” (best seen in FIG. 3) of tillage system 10. The operational width “W1” is the width of the ground surface 168 of an area of land being tilled that may be engaged and processed by the implements carried by tillage system 10. The operational width “W1” is discussed further below with regards to the soil flow through tillage system 10. First deflector 86 and second deflector 118 thereby help to prevent contamination of regions located outside of the first and second side boundaries and/or reduce or prevent soil build-up on regions outside of the first and second side boundaries.

Rear tillage assembly 20 may further include seventh lateral frame member 50 which is be positioned rearwardly of fifth lateral frame member 46. Seventh lateral frame member 50 is pivotably connected to fifth lateral frame member 46 via a pair of rear coupling arms 126. Rear coupling arms 126 may be pivotably mounted on a forward end to first mounting flanges 128 that are fixedly attached to and extend rearwardly from fifth lateral frame member 46. Rear coupling arms 126 may be pivotably connected to second mounting flanges 130 that are fixedly attached to and extend forwardly from seventh lateral frame member 50. Rear coupling arms 126 may be spaced apart laterally across frame 12 and are connected by sixth lateral frame member 48. Sixth lateral frame member 48 may be situated approximately at a midpoint between first mounting flanges 128 and second mounting flanges 130. Sixth lateral frame member 48 may be fixedly engaged with the rear coupling arms 126 via one or more intermediate mounting flanges 129. This allows sixth lateral frame member 48 to occupy a plane slightly above both fifth lateral frame member 46 and seventh lateral frame member 50. Disposed to one side of sixth lateral frame member 48 is a height adjustment member 132 which may be operationally connected to each of fifth lateral frame member 46, sixth lateral frame member 48, and seventh lateral frame member 50 via one or more of the first mounting flanges 128, intermediate mounting flanges 129, and/or second mounting flanges 130. An angled support brace 134 may likewise be included to provide structural integrity to the height adjustment member 132. Supporting brace 134 extends at an angle between the height adjustment member 132 on a forward end and sixth lateral frame member 48 on a rearward end. At its forward end, the height adjustment member 136 may attach to a height adjustment cylinder 136 extending between height adjustment member 132 and third mounting flanges 138 that extend forwardly from fifth lateral frame member 46. Height adjustment cylinder 136 may be a hydraulic cylinder or a piston or a manual adjustment cylinder as dictated by the desired implementation of tillage system 10. Cylinder 136 may be operated to control a vertical placement of fourth tillage implement 124 and any further implements that may be carried behind forth tillage implement 124 as discussed further herein.

Fourth tillage implement 124 may be operationally connected to seventh lateral frame member 50 by fourth mounting flanges 140. Fourth mounting flanges 140 may be fixedly engaged with seventh lateral frame member 50. According to one aspect and as shown in the figures, fourth tillage implement 124 may be a second reel 142 that is engaged with fourth mounting flanges 140 by a second reel mount 144. Second reel 142 may be substantially similar to first reel 112 and may include many of the features discussed above with respect to first reel 112. For example, second reel 142 may include a plurality of blades arranged in a generally helical pattern about second reel mount 144. Similarly to suspension spring 110, second reel 142 may further include a biasing spring or other similar device to apply downward force to the second reel 142 to maintain ground engagement when in use.

As with prior tillage implements 78, 104, and 116, fourth tillage implement 124 may be any tillage implement as dictated by the specific tillage requirements of the area to be tilled. According to another aspect, fourth tillage implement 124 may be alternatively supported by a secondary frame member that may be coupled to frame 12 to allow modular replacement thereof. Further, fourth tillage implement 124 may be configured for removable connection to frame 12 such that the entirety of fourth tillage implement 124 may be installed or removed from frame 12 without the need for tools or other equipment, such as a lift or trailer jack.

Similar to the arrangement of first and second tillage implements 78, 104 relative to each other, third and fourth tillage implements 116, 125 may be positioned in close proximity to each other. Specifically, where third tillage implement 116 is a row of discs 80 and fourth tillage implement 124 is a second reel 142, the rearward most edge of a disc 80 of third tillage implement 116 may be approximately 3 inches up to approximately 6 inches ahead of the forwardmost edge of second reel 142. According to another aspect, the distance between the rearward most edge of a disc 80 of third tillage implement 116 and the forwardmost edge of second reel 142 may be from approximately 3.4 inches up to approximately 5.7 inches. According to another aspect, this distance may be approximately 5.5 inches. This close proximity arrangement with third and fourth tillage implements helps to ensure efficient tilling of the soil.

In addition to providing connection points for fourth tillage implement 124, seventh lateral frame member 50 may also include connection points for one or more soil deflection plates 146, one or more finishing implements 148, and/or a containment shield 152. As depicted in FIG. 3, a soil deflection plate 146 may be provided on an end of fourth tillage implement 124 opposite the second deflector 118 (i.e. the left side of fourth tillage implement 124 as depicted in FIG. 3). Soil deflection plate 146 may angle outwardly and forwardly from a leading edge of second reel 142 and/or fourth tillage implement 124 to collect and gather soil that passes outside the outermost disc 80 in third tillage implement 116 and direct that gathered soil back into the operational width of tillage system 10. According to one aspect, soil deflection plate 146 may be positioned so that the outermost edge thereof is generally flush with, or slightly outside the first side boundary defined by first deflector 86. This positioning helps to ensure soil is fully contained within the operational width “W1” of tillage system 10. According to one aspect, soil deflection plate 146 may be oriented at an angle β (FIG. 3) relative to the direction of travel. According to one aspect, this angle β may be in a range from 25-45 degrees. According to another aspect, this angle may be approximately 30 degrees.

Soil deflection plate 146, as shown in FIG. 2A, may be engaged with second reel mount 144 and/or fourth mounting flange 140 by way of a soil deflection plate mount 154. Both soil deflection plate 146 and soil deflection plate mount 154 may include one or more vertical adjustment slots 156 that allow the height of soil deflection plate 146 to be adjusted relative to fourth tillage implement 124. This adjustability helps to ensure that the soil deflection plate 146 rides at or only slightly above the ground level and thereby helps to prevent soil from passing underneath soil deflection plate 146. Soil deflection plate mount 154 may be connected to second reel mount 144 by adjustment bolts 160 which pass through vertical adjustment slots 156 and through corresponding holes defined in second reel mount 144. Adjustment bolts 160 further facilitate the vertical adjustment of soil deflection plate mount 154. Similarly, soil deflection plate 146 may connect to soil deflection plate mount 154 via adjustment bolts 160. Soil deflection plate mount 154 may further include a rear portion 162 that is oriented substantially parallel to the direction of travel of tillage system 10, i.e., parallel to centerline “C”. This rear portion 162 may be the portion of soil deflection plate mount 154 that connects to second reel mount 144. Soil deflection plate mount 154 may also have a front portion 164 that is angled outwardly relative to rear portion 162, with the front portion 164 connecting to soil deflection plate 146. The angled relationship between rear portion 162 and front portion 164 is best seen in the top plan view of FIG. 3. Soil deflection plate mount 154 may further include a horizontally-oriented flange 166 extending therefrom that may help to reinforce soil deflection plate 146.

Soil deflection plate 146 further includes a horizontal adjustment slot 158 to allow adjustment of the position of soil deflection plate 146 relative to the front portion 164 of soil deflection plate mount 154. The horizontal adjustment slot 158 may be defined in the soil deflection plate 146 such that adjustment bolts 160 may simultaneously pass through the vertical adjustment slots 156 and the horizontal adjustment slot 158. Utilizing the same adjustment bolts 160 for both vertical and horizontal adjustment slots 156, 158 may allow rapid positional changes to soil deflection plate 146. These position changes may be made in the field with no tools or with a minimal number of tools. According to one aspect, adjustment bolts 160 may include a thumb knob or other means to allow hand adjustment of soil deflection plate 146 without the need for using tools.

Rear tillage assembly 20 may further include a finishing implement 148 which may be operationally connected to fourth mounting flanges 140 by finishing implement mount 150. According to one aspect, the finishing implement 148 may be a rear basket. According to another aspect, the finishing implement 148 may be a finishing roller (FIG. 1B). Finishing implement 148 may provide a greater degree of leveling than implements such as discs 80 and/or reels 112, 124, and thereby provides a smoother, more even surface behind tillage system 10. Various finishing implements may be engaged with tillage system 10 so as to create custom soil profiles specific to the tillage needs of the area of land being tilled.

Rear tillage assembly 20 may further include one or more optional containment shields 152 (best seen in FIG. 1B) mounted between the second reel mounts 144 and the finishing implement mounts 150. The containment shields 152 further help to contain soil between the second reel 142 and the finishing implement 148 as soil flows through tillage system 10. Containment shield 152 may be fixedly or removably attached between second reel mount 144 and finishing implement mount 150 so as to allow optional placement of the containment shield 152 as dictated by the tillage requirements in the area to be tilled. Containment shield 152 may further include adjustment slots and adjustment bolts (similar to slots 156 and 158 and bolts 160 of soil deflection plate 146 and soil deflection plate mount 154) to allow positional adjustment of containment shield 152 to help prevent soil from passing under shield 152 during use of tillage system 10. According to one aspect, containment shield(s) 152 may be desirable for use with some finishing implements 148 (e.g. finishing rollers) but may not be desirable for use with outer types of finishing implements. Thus, containment shield(s) 152 may be installed or removed as desired according to the particular configuration of tillage system 10 and/or the specific tillage requirements of an area to be tilled.

According to one embodiment, front tillage assembly 18 may include a plurality of interchangeable tillage implements, such as discs 80, first reel 112, and/or any other type of tillage implement according to the specific tillage needs of a particular area to be tilled. Similarly, rear tillage assembly 20 may include a plurality of interchangeable tillage implements, such as discs 80, second reel 142, finishing implement 148, and/or any other type of tillage implement according to the specific tillage needs of a particular area to be tilled. It will be understood that these implements may be interchangeable and may vary depending on specific tillage needs. Additionally, the various tillage implements may be arranged in any order suitable for the needs of the area of land that is to be tilled. For example, an implement that cuts and/or uproots vegetation may be located forwardly of an implement that cuts into the soil or vice versa.

According to one aspect, tillage implements, including first, second, third, and fourth tillage implements 78, 104, 116, and 124, may be releasably coupled to the various mounting surfaces and mounting brackets carried by frame 12. According to another aspect, tillage implements may be modular in that one or more tillage implements may share a common mounting arrangement to the frame 12. Thus, these modules may be disconnected and reconfigured (i.e., removed and then subsequently reengaged on the frame 12 in a different order) so as to accommodate specific tillage requirements. According to one non-limiting example, front tillage assembly 18 may be a first module carrying multiple implements in multiple corresponding rows (e.g. discs 80 and first reel 112 of first and second tillage implements 78 and 104) while rear tillage assembly 20 may be a second module carrying multiple implements in corresponding rows (e.g. discs 80, second reel 142, and finishing implement 148). Other tillage implement arrangements may be pre-configured and may be swapped in or out of connection with frame 12 as needed, and as further discussed herein. Furthermore, any module may be mounted at any position along the longitudinal length of tillage system 10. For example, front and rear tillage assemblies 18, 20 may be swapped in position so that rear tillage assembly 20 precedes front tillage assembly 18 when tillage system 10 is viewed from front end 22. Accordingly, the modular nature of tillage system 10, further according to this embodiment, may allow any combination of tillage implements in any desired order and may be varied, changed, or adjusted to meet specific tillage requirements.

Further according to this embodiment, and for the purposes of interchangeability, front coupling arms 106 and rear coupling arms 126 may be substantially similar. Other such mounting points, including mounting flanges 109, 128, 129, 130, 138, 140, support flanges 108, adjustment slots 92, 98, 156, 158, adjustment screws 94, 100, adjustment bolts 160, and/or any other connections shown or described herein may be substantially similar to each of their counterparts to allow further interchangeable mounting of components and implements thereto.

Although tillage system 10 is described and illustrated herein as being towed by a vehicle via hitch assembly 14, it will be understood and readily apparent that tillage system 10, including any or all components thereof, may be adapted for use with a three-point mounting system, or with any other attachment system as dictated by the desired implementation, without deviation from the scope herein. Furthermore, tillage system 10 may be configured to be mounted so that it is located in front of a powered vehicle that moves the system across an area to be tilled instead of being towed behind such a vehicle.

According to one aspect, all embodiments of tillage system 10 may utilize tool-less connection means, such as pins, locking pins, cotter pins, clamps, and the like to connect tillage implements to frame 12 in each of the tillage implements 78, 104, 116, and/or 124, as well as to module or secondary frame members, if employed. The use of tool-less connections may allow for rapid service, installation, and/or removal, which may further allow tillage system 10 to be modified in the field to vary the tillage operation thereof, as discussed below.

According to another embodiment, tillage system 10 may further include or otherwise carry a container system coupled to frame 12. This container system may be, for example, a fertilizer or herbicide tank and associated spraying equipment. The container system may apply any material on or into the soil as needed and may be placed on frame 12 in any suitable position as dictated by the desired implementation and use thereof. Alternatively or additionally, the container system may include a planter hopper and distribution equipment to sow seeds or insert seedlings into the soil.

Having thus described the components and features of tillage system 10, the operation and method of use therefore will now be discussed.

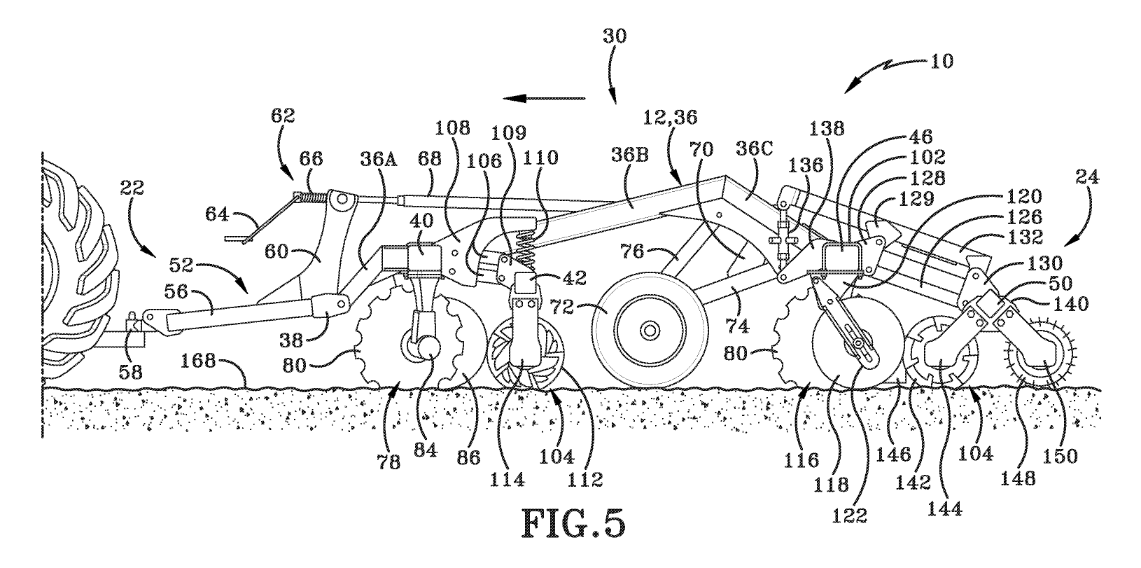

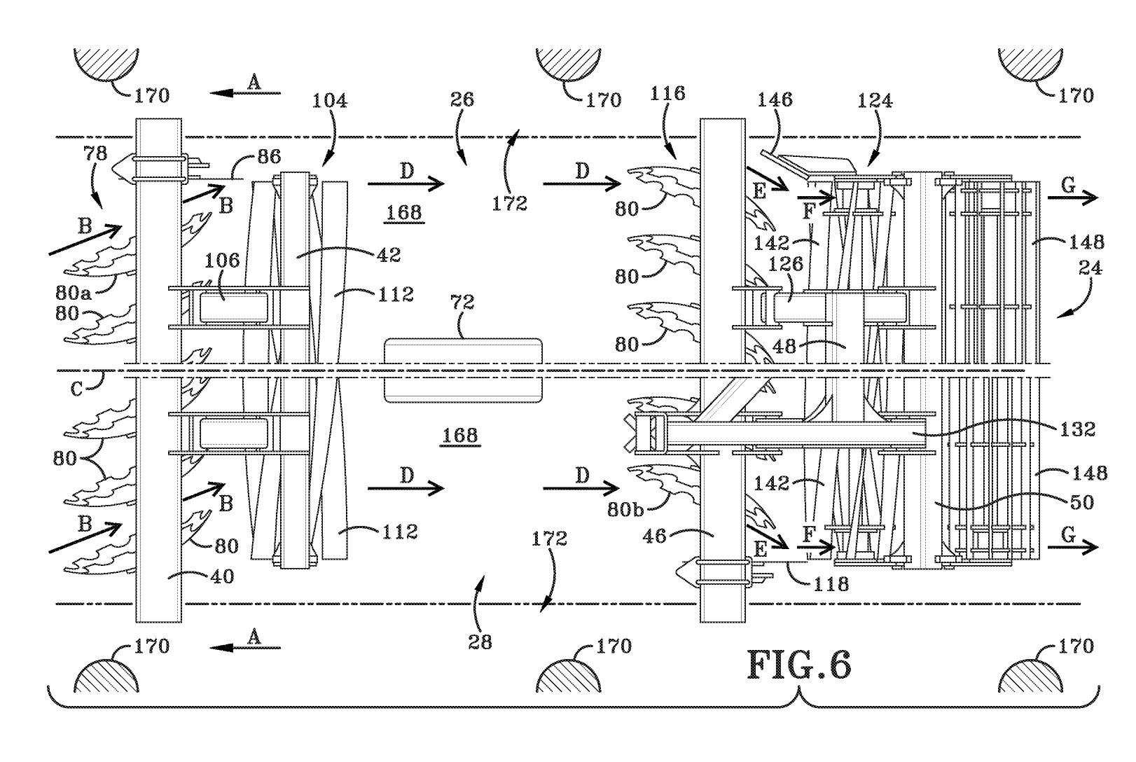

With reference to FIGS. 5 and 6, tillage system 10 is contemplated to be towed behind or otherwise pulled by a vehicle, such as a tractor, ATV, or the like. Part of a rear wheel of the towing vehicle is shown in FIG. 5. The direction of travel is understood to be towards the front end 22 of tillage system 10 in the direction as indicated by the solid arrow in FIG. 5 and solid arrows at the top and bottom of FIG. 6. The user will select, arrange, and engage tillage implements on frame 12 of tillage system according to the desired tillage requirements of the area being tilled. As illustrated, tillage system 10 has first, second, third, and fourth tillage implements 78, 104, 116, 124, as well as finishing implement 148 engaged on frame 12.

As tillage system 10 is towed across an area of land to be tilled, the first, second, third, and fourth tillage implements 78, 104, 116, 124, as well as finishing implement 148, engage the soil or ground surface 168. Each of the implements performs the particular tillage operation that it is designed to perform. When configured as illustrated in FIGS. 5 and 6, tillage system 10 may take untilled, uneven, and/or vegetation covered ground, and may process the soil and/or vegetation therein to achieve a smooth and uniform soil surface behind tillage system 10.

Specifically, discs 80 of first tillage implement 78 are rotated to cut into and break up the soil to a certain depth and turn the disturbed soil over. The discs 80 of first tillage implement 78 may tend to push or move at least some of the soil laterally to a first side, for example to the left, as illustrated in the figures, with respect to the direction of travel, indicated by arrows “A”. This is because the discs 80 are angled slightly relative to the direction of travel, as indicated earlier herein. This lateral movement of the soil within the operational width “W1” is referred to generally as soil flow and is shown in FIG. 6 by the arrows “B”.

More specifically, according to example shown in FIG. 6, discs 80 placed to the right of the centerline “C” of tillage system 10 in first tillage implement 78 may direct soil towards the midline or centerline “C” of tillage implement 10 and that soil will be properly processed and contained therein. However, discs 80 to the left of centerline “C” in first tillage implement 78 may direct soil to the left and away from the centerline “C” of tillage implement 10. The last disc 80 in first tillage implement 78 may therefore tend to direct soil beyond the outer reach of the second tillage implement 104. However, the placement of first deflector 86 at the end of first tillage implement 78 may serve to contain soil coming off of the last disc 80 such that this soil remains within the path of second tillage implement 104 and/or within the operational width “W1” of tillage system 10. Specifically, as discs 80 of first tillage implement 78 move soil to the first side, soil exiting the disc 80a on the farthest extreme of first tillage implement 78 may encounter first deflector 86. First deflector 86 engages the ground surface 168 and may further define the outermost first side boundary of soil moving through tillage system 10 to the first side. Thus, soil encountering first deflector 86 may be defined as a first soil flow. First deflector 86 deflects some or all of the soil leaving disc 80a of first tillage implement 78 and causes that soil flow rearwardly. First deflector 86 thus serves to contain that soil within the path of the second tillage implement 104, which, according to this aspect, is first reel 112.

The positioning of first reel 112 immediately behind the discs 80 of first tillage implement 78 may allow first reel 112 to “catch” the soil processed by the discs 80 and redirect at least some of the soil rearwardly. This arrangement may control soil flow by preventing clumps of soil from escaping from underneath the discs 80 and first reel 112. The first reel 112 also serves to break up clumps of soil created through the tilling of the soil by first tillage implement 78. Soil exiting the first reel 112 tends to be further processed and the number and size of soil clumps may be reduced. Further, the close proximity of first reel 112 to the rearward most edge of discs 80 of the first tillage implement 78 helps to ensure that the maximum amount of soil tilled by discs 80 is caught by first reel 112, thus minimizing the amount of soil that may otherwise be missed by first reel 112. The close proximity of the first and second tillage implements 78, 104 may also cause soil that is picked up and moved by the discs 80 of the first tillage implement 78 to be directed onto and caught by the first reel 112 before the soil clumps contact the ground. This reduces the need for first reel 112 to pick up the soil clumps from the ground before processing the same.

As tillage system 10 continues to move forwardly in the direction indicated by arrows “A”, soil that has passed through first and second implements 78, 104 will tend to move rearwardly in the direction indicated by arrows “D” and next encounter third tillage implement 116. Third tillage implement 116, as disclosed, may include a second set of discs 80. The discs 80 of third tillage implement 116 may be oriented in an opposite direction to the discs 80 of first tillage implement 78. This different orientation of the discs 80 helps cut soil clods into smaller pieces and further churns up the soil as the discs 80 are rotated. The differently oriented discs 80 may cause at least some of the tilled soil to be moved toward a second side of tillage system 10, for example to the right, with respect to the direction of travel. Specifically, according to this example, discs to the left of centerline “C” in third tillage implement 116 of tillage system 10 will now move soil left to right towards the centerline “C” of tillage system 10 while discs 80 placed to the right of centerline “C” in third tillage implement 116 will move soil away from centerline “C” of tillage system 10 and toward the second side of tillage system 10. In other words, the discs 80 move the soil in the direction indicated by arrows “E”. The last disc 80b in third tillage implement 116 may cause soil to be displaced beyond the side edge of fourth tillage implement 124. Therefore, the placement of second deflector 118 prevents the soil from moving beyond it and thereby serves to contain such soil within the path of fourth tillage implement 124 and/or within the operational width “W1” of tillage system 10 for further processing. Similar to first deflector 86, second deflector 118 may also engage the ground surface 168 and define the outermost boundary of soil moving through tillage system 10 to the second side. Thus, soil encountering second deflector 118 may be further defined as a second soil flow. Second deflector 86 may further engage soil leaving discs 80 of third tillage implement 116 and may serve to contain that soil within the path of the fourth tillage implement 124, which, according to this aspect, may be second reel 142.

The discs 80 of third tillage implement 116 may turn the soil over a second time while second reel 142 may catch the soil thrown from discs 80 further preventing clumps of soil from escaping from underneath the discs 80 of third tillage implement 116 and second reel module 142. Further, the close proximity of second reel 142 to the rearward most edge of discs 80 of third tillage implement 116 may ensure that the maximum amount of soil thrown by discs 80 is caught by second reel 142, thus minimizing the amount of soil that may otherwise be missed by second reel 142. The close proximity of the third and fourth tillage implements 116, 124 may also provide that the soil thrown by the discs 80 of third tillage implement 116 is caught by the second reel 142 and therefore does not necessitate that the soil be picked up from the ground surface by the second reel 142.

Portions of the first soil flow to the extreme first side 26 of tillage system 10 may occasionally pass outside of the outermost disc 80 in the third tillage implement 116. In normal tillage operations, this soil would be collected and processed in subsequent tillage passes; however, in the understood operation of tillage system 10 in areas with space limitations, such as between orchard rows, tillage system 10 may not make a second pass over the arear of land being tilled. Therefore any soil not collected and redirected back into the rear disc 80 depressions would be left and may accumulate or otherwise contaminate the berms 172 of orchard plants 170 or other areas not to be tilled. To remedy this, tillage system 10 is provided with the soil deflection plate 146 which may be disposed to the far side of fourth tillage implement 124 opposite second deflector 118. Soil deflection plate 146 and may extend outwardly and forwardly from fourth tillage implement 124 and serves to gather and redirect any of the first soil flow missed by the discs 80 of third tillage implement 116 as indicated by arrow “F”. Any such soil of the first soil flow caught by soil deflection plate 146 may be redirected into the path of fourth tillage implement 124 or back into the operational width “W1” of tillage system 10 and will be processed therethrough. Soil deflection plate 146 may be further operable to catch any soil that may have been processed by first and/or second tillage implements 78, 104, but that was missed by third tillage implement.

As soil exits the rear of second reel 142, it may encounter finishing implement 148 where it may be further processed to achieve the desired end result. The addition of finishing implement 148 may operate to further break down any remaining clumps of soil and help to seal moisture in the soil. Finishing implement 148 may also level the soil or produce a soil surface texture conducive to planting a seed bed, if desired. Soil flow exits tillage system 10 as indicated by arrows “G”.

The placement of the containment shield 152 at one or both lateral ends of rear tillage assembly 20 may further serve to keep soil that has been processed through first, second, third, and/or fourth implements 78, 104, 116, and 124, from escaping the left and right sides of rear tillage assembly 20. Further, containment shields 152 may direct soil through finishing implement 148 to further ensure that all or substantially all soil flowing through tillage system 10 is processed fully and left with the desired soil profile.

The heights of front and rear tillage assemblies 18 and 20 may be adjusted to control the depth at which the individual tillage implements installed on tillage system 10 penetrate the ground surface 168. Specifically, the height front tillage assembly 18 may be adjusted through adjustment of the weight provided on hitch assembly 14 and/or by the weight provided on first reel 112. The weight on first reel 112 may be adjusted by increasing downward pressure applied by suspension springs 110, or by providing additional downward force thereon. This additional downward force will increase the penetration depth of discs 80 of first tillage implement 78 accordingly. Similarly, the height of rear tillage assembly 20 may be adjusted by raising or lowering the fourth implement 124 via height adjustment member 132. The configuration of height adjustment member 132 and the associated frame 12 components allows for the finishing implement 148 to be raised or lowered alongside fourth tillage implement 124, and in turn may cause the depth of penetration by discs 80 of third tillage implement 116 to change as well.

Wheel assembly 16 may be raised or lowered through operation of wheel assembly adjustment mechanism 62. Although FIG. 5 illustrates that tillage system 10 may be operated with the wheels 72 in the deployed condition, it will be understood that the wheels 72 and wheel assembly do not control the depth of the implements 78, 104, 116, and/or 124. Instead, wheels 72 and wheel assembly 16 may be used to transport tillage system 10, or to alternatively provide stabilization to tillage system 10 when operated with the wheels 72 in the deployed condition. It will be further understood that where the engagement of wheels 72 with ground surface 168 is not desired, wheels 72 may be lifted off the ground and the operation of tillage system 10 may be unaffected. Specifically, tillage system 10 may be operable to provide equal results in both a wheels 72 stowed or a wheels 72 deployed condition.

The arrangement of tillage system 10 with first and third tillage implements 78, 116 being discs 80, and second and fourth tillage implements 104, 124 being reels 112, 142 thereby allows all or substantially all soil flowing through tillage system 10 to be processed, resulting in a more uniformly finished soil surface. Accordingly, the portion of the ground surface 168 that is covered by operational width “W1” defined by first and second deflectors 86, 118, may be tilled and the soil engaged therefrom may be fully processed as the combination of first deflector 86, second deflector 118, and soil deflector plate 146 helps ensure that little to no soil escapes out of either the left or right sides 26, 28 of tillage system 10.

It may be desirable to turn the soil once with discs 80 of the first tillage implement 78 to aerate the soil, and then turn it back over again with discs 80 of the third tillage implement 116 as this helps reduce the loss of moisture from the soil. Moreover, where vegetation may be growing in the area to be tilled, turning the soil over with discs 80 may bury the vegetation underground where it can decompose and provide nutrients to the soil. The configuration of tillage system 10 allows for these, and other tillage processes, to be performed in a single pass over an area to be tilled.

As tillage system 10 is towed over an area to be tilled, the operational width “W1” thereof may be equal to or less than the overall width “W” of tillage system 10, and may be defined by the position of first and second deflectors 86, 118, as discussed previously.

It is contemplated that tillage system 10 may be used in an orchard or vineyard between rows of trees or the like. Therefore, it is important that soil is contained between the berms 172 surrounding the orchard plants 170, the boundaries of which are indicated by the dot-dot-dash lines in FIG. 6. As the soil being tilled may include vegetation, such as weeds and undergrowth as well as seeds and mummy fruit or nuts, that have been left behind from previous harvests, it is important to keep this soil from mixing with the berm 172 soil surrounding orchard plants 170 as these inclusions within the soil may contaminate the berms 172, thus, reducing the output of the orchard plants 170 over time. Further, as the vegetation and/or mummy fruit or nuts may contain pests or parasites, it is equally important to remove, destroy, or otherwise eliminate those from the area surrounding the orchard plants 170 for the overall health of the plants 170. Accordingly, tillage system 10 may control the flow of soil through tillage system 10 through use of first deflector 86, second deflector 118, soil deflection plate 146, and/or containment shields 152 as illustrated in FIG. 6 and described above.

As discussed above, tillage system 10 may be utilized using any tillage implement for carrying out a variety of tillage functions. Further, tillage system 10 may be of modular construction, and may utilize tool-less connection means to allow for quick and easy service, installation, and/or removal of specific tillage implements from frame 12. Accordingly, it will be understood that any combination of tillage implements, provided in any order is within the scope of the present disclosure.

The order in which the tillage modules or implements are arranged and coupled to tillage system 10 may be predetermined after taking into account a variety of factors and/or tillage requirements of the area to be tilled. These factors and/or requirements may comprise one or more of primary tillage, secondary tillage, intensive tillage, reduced tillage, conservation tillage, seasonal crop rotation tillage, crop-specific tillage, depth-specific tillage, strip tillage, ridge tillage, reservoir tillage, soil moisture content, amount of crop residue in or on the soil, soil erosion characteristics, soil water infiltration rate, soil nutrient content, soil insect content, soil compaction, and the like.

Therefore, and pursuant to one aspect, tillage system 10 may be used according to the following method. First, an analysis of the tillage requirements of an area or areas of land to be tilled may be made, identifying the specific factors and needs of the area to be tilled. Specifically, the analysis of the area or areas of land to be tilled may permit an operator to determine the specific tillage requirements of each area of land to be tilled and to further configure tillage system 10 to best meet those requirements. Configuring tillage system 10 may include selecting specific tillage implements to install on the frame 12 of tillage system 10, as well as the positional order of those implements. Once the analysis is complete, and the implements have been selected and configured (i.e., arranged in a particular order), the selected tillage implements may be releasably coupled to frame 12 in an order best contemplated to accomplish the specific tillage goals of the specific area of land to be tilled. It is common for a single operator of a tillage system, such as tillage system 10, to oversee multiple areas to be tilled, each with its own tillage requirements. The operator may analyze the various multiple areas to be tilled and will plan which implements to use, which configuration to use those implements and in which order to till the various areas. All this analysis and planning may occur before the first set of tillage implements are engaged with the frame 12. After planning and selecting the tillage implements, tillage system 10 may be first set up for a first area to be tilled, having a specific configuration to best meet the needs of that area. Implements for the specific tillage requirements of the first area of land to be tilled are installed onto frame 12. The operator may then traverse the first area of land to be tilled towing tillage system 10 across the land, thereby tilling the first area.

Once tillage the first area of land is complete, the operator may return to where he or she stores the tillage implements and tillage system 10 may be quickly reconfigured to meet the tillage requirements of a second area to be tilled. Specifically, the implements for the first area of tilled land may be removed from frame 12 and the implements selected and configured for a second area of land to be tilled may be installed, at which point, the operator may proceed to traverse the second area with tillage system 10 to till the land. The reconfiguration of tillage system 10 may be accomplished quickly and easily by virtue of the arched shape of frame 12, along with the tool-less coupling of implements to frame 12. It will be understood that some of the implements used to till the first area of land may be left engaged with the frame for the tilling of the second area or they may be moved from one location to another on the frame prior to tilling the second area.

This method of use may be best explained by way of a simplified and non-limiting example. According to this example, tillage system 10 may be configured to till a first orchard area with a specific need, such as an overgrowth of vegetation between orchard rows. Thus tillage system 10 may be equipped with the first through fourth tillage implements 78, 104, 116, and 124, to best deal with vegetation, along with an appropriate finishing implement 148. An operator may then tow tillage system 10 through the first orchard. Once the first orchard is tilled, tillage system 10 may be reconfigured to till a second orchard with a difference specific need, such as soil leveling. The operator may return to the place where his or her tillage implements are stored, and may quickly access and remove the previously installed tillage implements, i.e., one or more of the first through fourth tillage implements 78, 104, 116, and/or 124, and may replace the removed implements with other implements. The operator may further choose to replace the finishing implement 148 to better achieve the desired result. The arched shape of frame 12 makes it easy for the operator to access the various implements and makes it easier to remove and install the same. Additionally, the provision of tool-less connection mechanisms to secure the various implements to frame 12 makes it relatively easy and quick to remove and/or install the various implements. Thus, the operator saves time and may begin tilling the second orchard area without undue delay.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A method of soil flow management comprising:
traversing an area of land to be tilled with a tillage system having a frame carrying a first tillage assembly and a second tillage assembly thereon;
processing the soil underneath the tillage system with the first tillage assembly and the second tillage assembly as the tillage system travels forwardly across the area of land;
directing a first part of the processed soil as a first soil flow toward a first side of the tillage system with one of the first tillage assembly and the second tillage assembly; and
containing at least a part of the first soil flow within a first side boundary and within an operational width of the tillage system utilizing a first deflector.

2. The method of claim 1, further comprising:
directing a second part of the processed soil as a second soil flow toward a second side of the tillage system with the other of the first tillage assembly and the second tillage assembly; and
containing the second soil flow within a second side boundary and within the operational width of the tillage system utilizing a second deflector.

3. The method of claim 2, further comprising:
capturing a part of the first soil flow that bypasses the second tillage assembly with a soil deflection plate; and
redirecting the part of the first soil flow back into the operational width of the tillage system.

4. The method of claim 3, further comprising:
leaving a ground surface outside of the first side boundary and the second side boundary of the tillage system substantially undisturbed.

5. The method of claim 1, wherein the first tillage assembly comprises a first tillage implement and a second tillage implement and wherein the method further comprises:
positioning the second tillage implement between 3 inches and 6 inches rearwardly from the first tillage implement.

6. The method of claim 5, further comprising:
positioning the second tillage implement between 3.4 inches and 5.7 inches rearwardly from the first tillage implement.

7. The method of claim 1, wherein the first tillage assembly includes a first tillage implement and the method further comprises:
locating the first deflector at least partially rearwardly from the first tillage implement.

8. The method of claim 2, wherein the second tillage assembly includes a second tillage implement and the method further comprises:
locating the second deflector at least partially rearwardly from the second tillage implement.

9. The method of claim 8, wherein the second tillage assembly further comprises an additional tillage implement and the method further comprises:
locating a soil deflection plate at least partially forwardly from the additional tillage implement and opposite the second deflector.

10. The method of claim 9, further comprising:
processing substantially all of the soil through the additional tillage implement carried by the second tillage assembly.

11. The method of claim 9, further comprising:
locating a finishing implement rearwardly of the additional tillage implement; and
applying the finishing implement to the substantially all of the soil processed by the tillage system.

12. A method of tilling comprising:
analyzing a first area of land to be tilled;
determining tillage requirements of the first area of land;
selecting a first plurality of tillage implements suitable to perform the tillage requirements of the first area of land;
configuring a tillage system with a frame to the tillage requirements of the first area of land;
installing the first plurality of tillage implements onto the frame;
traversing the first area of land with the tillage system;
tilling the first area of land with the plurality of first tillage implements;
analyzing a second area of land to be tilled;
determining the tillage requirements of the second area of land;
selecting a second plurality of tillage implements suitable to perform the tillage requirements of the second area of land;
removing the first plurality of tillage implements from the frame;
reconfiguring the tillage system to carry the second plurality of tillage implements;
installing the second plurality of tillage implements onto the frame; and
tilling the second area of land with the second plurality of tillage implements.

13. The method of claim 12, wherein the installation and removal of the first plurality of tillage implements and the second plurality of tillage implements are performed without using tools.

14. The method of claim 12, wherein the analyzing of the first area of land and the analyzing of the second area of land are performed prior to installing the first plurality of tillage implements onto the frame.

15. The method of claim 12, further comprising:
installing a first deflector proximate a first side of the tillage system;
installing a second deflector proximate a second side of the tillage system; and
defining an operational width of the tillage system between the first deflector and the second deflector.

16. The method of claim 15, further comprising:
containing substantially all of the soil processed by the tillage system within the operational width.

17. A tillage system comprising:
a frame having a first side and a second side;
a front tillage assembly engaged with the frame and carrying at least one tillage implement thereon;
a first deflector provided on the front tillage assembly and defining an operational first side boundary of the tillage system;
a rear tillage assembly engaged with frame and carrying at least one tillage implement thereon;
a second deflector provided on the rear tillage assembly and defining an operational second side boundary of the tillage system; and
wherein the first deflector and the second deflector are adapted to contain processed soil between the first side boundary and the second side boundary.

18. The tillage system of claim 17, further comprising:
a soil deflection plate in operational communication with the rear tillage assembly, said soil deflection plate located laterally spaced apart from and opposite the second deflector.

19. The tillage system of claim 17, wherein the frame includes an arched section that is located between the front tillage assembly and the rear tillage assembly.

20. The tillage system of claim 17, wherein the front tillage assembly comprises a first tillage implement and a second tillage implement located in close proximity to each other; and wherein the rear tillage assembly comprises a third tillage implement and a fourth tillage implement, and the third tillage implement and fourth tillage implement are located in close proximity to each other.
